(19) United States
(12) Patent Application Publication
(10) Pub. No.: US 2025/0307231 A1
(43) Pub. Date: Oct. 2, 2025

(54) METHODS AND SYSTEMS FOR HIGH TRUST DATA GOVERNANCE AND STEWARDSHIP

(71) Applicant: Tiny Maple Ventures Inc., Toronto (CA)

(72) Inventor: Ryan Doherty, Toronto (CA)

(21) Appl. No.: 19/094,057

(22) Filed: Mar. 28, 2025

Related U.S. Application Data
(60) Provisional application No. 63/570,943, filed on Mar. 28, 2024.

(51) Int. Cl. G06F 16/23

(52) U.S. Cl. CPC G06F 16/2365

(57) ABSTRACT

Described herein are systems, methods, and non-transitory computer readable medium for building a high trust dataset. The method for building a high trust dataset may comprise. repeatedly, retrieving data from a plurality of data sources each having an associated trust score, identifying at least one subset of the retrieved data which conflicts with at least one of another subset of the retrieved data and the high trust dataset, for each identified subset of the retrieved data, selecting one of the plurality of data sources from which the subset will be included in the high trust dataset based on the associated trust score, based on the trust score, updating the high trust dataset to comprise the subset from the selected one of the plurality of data sources, and updating the associated trust score of at least one of the plurality of data sources.

### CROSS REFERENCE TO RELATED APPLICATIONS

This application claims the benefit of the filing date of U.S. Provisional Patent Application Ser. No. 63/570,943, filed Mar. 28, 2024, the specification of which is incorporated herein by reference.

### FIELD

The specification relates generally to data governance and trust, and specifically to systems and methods for building high trust datasets.

### BACKGROUND

Different entities often rely on data retrieved from a single or variety of data sources without strong data governance. This can be problematic as those sources may have varying levels of accuracy, completeness, and data quality. Those data sources may also update their data at varying rates, meaning that without a way to efficiently determine or otherwise identify when a data source has been updated and/or when context regarding the data changes, one risks inadvertently utilizing stale and/or inadequate data, which may limit the effectiveness of planning due to using incomplete and/or inaccurate information. Further, without a centralized high trust dataset, many entities may individually be required to evaluate the accuracy of certain data, which may require excess human and/or computer resources. Within the field of healthcare, poor data quality can have a significant negative impact on budgets, planning, coordination of services, access to care, and environmental impact.

### SUMMARY OF THE INVENTION

This summary is intended to introduce the reader to the more detailed description that follows and not to limit or define any claimed or as yet unclaimed invention. One or more inventions may reside in any combination or sub-combination of the elements or method steps disclosed in any part of this document including its claims and figures.

According to one aspect of this disclosure, there is provided a method for building a high trust dataset. The method for building a high trust dataset may include, repeatedly, retrieving data from a plurality of data sources, wherein one or more of the plurality of data sources may comprise structured and/or unstructured data and each one of the plurality of data sources may have an associated trust score, identifying at least one subset of the retrieved data which conflicts with at least one of another subset of the retrieved data and the high trust dataset, for each identified subset of the retrieved data, selecting one of the plurality of data sources from which the subset will be included in the high trust dataset based on the associated trust score, based on the trust score, updating the high trust dataset to comprise the subset from the selected one of the plurality of data sources, and updating the associated trust score of at least one of the plurality of data sources.

In some embodiments, identifying may include identifying the subset and the another subset as analogous; comparing the subset with the another subset of retrieved data; and determining at least one conflict between the subset and the another subset.

In some embodiments, identifying may comprise identifying each of the subset, the another subset, and a subset of the high trust dataset as conflicting.

In some embodiments, the trust scores of the plurality of data sources may comprise at least one high trust score and at least one low trust score.

In some embodiments, the plurality of data sources may comprise one or more of a database, a data feed and a data structure.

In some embodiments, each one of the plurality of data sources may be updated at different frequencies.

In some embodiments, at least one of the plurality of data sources may be associated with a healthcare entity.

In some embodiments, the updating may comprise updating in in real-time.

In some embodiments, the updating may comprise use of at least one of artificial intelligence and data analytics.

In some embodiments, at least one of the artificial intelligence and the data analytic may be based on one or more of historical data, contextual data and data type.

In some embodiments, the method may further comprise predicting a trust score of a data source using artificial intelligence.

In some embodiments, the artificial intelligence may comprise one or more of machine learning and artificial generative intelligence.

In some embodiments, the machine learning may comprise one or more artificial neural networks.

In some embodiments, a frequency of the repeating may be in accordance with the results of applied artificial intelligence.

In some embodiments, the method may further comprise providing the high trust dataset to at least one downstream system.

In accordance with another aspect, there is provided a system for building a high trust dataset. The system for building a high trust dataset may comprise a data handling engine in communication with a plurality of data sources, at least one memory device configured to store computer-executable instructions and the high trust dataset, and a processing device coupled to the memory device. The computer executable instructions when executed by the processing device may cause the processing device to, repeatedly, retrieve data from the plurality of data sources, wherein one or more of the plurality of data sources may comprise structured and/or unstructured data and each one of the plurality of data sources may have an associated trust score, identify at least one subset of the retrieved data which conflicts with at least one of another subset of the retrieved data and the high trust dataset, for each identified subset of the retrieved data, select one of the plurality of data sources from which the subset will be included in the high trust dataset based on the trust score, based on the trust score, update the high trust dataset stored at the at least one memory device to comprise the subset from the selected one of the plurality of data sources, and update the trust score of at least one of the plurality of data sources.

In some embodiments, the retrieved data is encrypted and the computer-executable instructions when executed by the processing device further causes the processing device to decrypt the retrieved data.

In some embodiments, the system further comprises an application interface for the data handling engine.

In some embodiments, the system may further comprise a plurality of downstream systems having access to the high trust dataset.

In accordance with another aspect, there is provided a non-transitory computer readable medium for building a high trust dataset. The non-transitory computer readable medium for building a high trust dataset may comprise computer-executable instructions. The computer-executable instructions for, repeatedly, retrieving data from a plurality of data sources, wherein one or more of the plurality of data sources may comprise structured and/or unstructured data and each one of the plurality of data sources may have an associated trust score, identifying at least one subset of the retrieved data which conflicts with another subset of the retrieved data and/or the high trust dataset, for each identified subset of the retrieved data, selecting one of the plurality of data sources from which the subset will be included in the high trust dataset based on the trust score, based on the trust score, updating the high trust dataset to comprise the subset from the selected one of the plurality of data sources, and updating the trust score of at least one of the plurality of data sources.

### BRIEF DESCRIPTIONS OF THE DRAWINGS

For a better understanding of the various aspects of the application described herein and to show more clearly how they may be carried into effect, reference will now be made, by way of example only, to the accompanying drawings in which:

FIG. 1 depicts a schematic of a system for building a high trust dataset, according to non-limiting embodiments;

FIG. 2 depicts an illustrative example of certain aspects of processes performed by the system for building a high trust dataset, according to non-limiting embodiments; and

FIG. 3 depicts a flowchart illustrating a method of building a high trust dataset, according to non-limiting embodiments.

### DETAILED DESCRIPTION

Herein described are systems and methods for high trust data governance. It will be appreciated that for simplicity and clarity of illustration, where considered appropriate, reference numerals may be repeated among the figures to indicate corresponding or analogous elements. In addition, numerous specific details are set forth in order to provide a thorough understanding of the exemplary aspects of the present application described herein. However, it will be understood by those of ordinary skill in the art that the exemplary aspects described herein may be practiced without these specific details. In other instances, well-known methods, procedures, and components have not been described in detail so as not to obscure the exemplary aspects described herein. Also, the description is not to be considered as limiting the scope of the exemplary aspects described herein. Any systems, method steps, components, parts of components, and the like described herein in the singular are to be interpreted as also including a description of such systems, method steps, components, parts of components, and the like in the plural, and vice versa.

As alluded to above, there are many challenges to building high trust datasets particularly when those datasets rely on data or information (e.g., the frequency at which data is updated and the reliability of that data) from sources outside of the control of the system building the high trust dataset. Different types of data change or are updated at different rates. For example, many healthcare directories are maintained infrequently (e.g., professional colleges updating healthcare information about registered healthcare professionals are updated annually or when the professional updates their registration). In some cases, while the data may rarely be updated, the context related to that data may change instead. In other cases, the data may be updated frequently and the context surrounding that data may also change frequently. Context related to the data, may include, for example, rural vs. urban location of healthcare provider, business information vs. clinical information of a patient, IT infrastructure used by healthcare organizations, whether a healthcare professional or organization is part of a larger institution such as (a) a hospital, (b) a primary care network, (c) a family health team, (d) a regional healthcare organization, or (e) a public health department, purpose for collecting the data (e.g., for billing purposes, program registration, or for health records). Purpose also affects data quality. For example, most government data sources are collected and/or maintained using processes designed for specific purposes that may not be congruous with building a high trust dataset using that information as a constituent. For example, many government directory services for Canadian provinces were designed for phone-based navigation, directories utilized solely for billing and certification purposes, referral-based access or to provide information regarding non-healthcare community services, which do not rely on urgent updates or high data quality when the envisioned access to those directories was on an infrequent basis (e.g., booking a specialist physician appointment is usually done 6 to 9 months in the future). This is in contrast to services that rely on patient self-navigation and access to same-day, urgent healthcare services (e.g., after hours urgent care medical appointments) when phone-based navigation is not possible. Many existing solutions focus on cost efficiencies that treat all data from all sources the same (e.g., collect all information from 80% of providers once a year), assuming that a single data source is fit for purpose.

In contrast, the described methods and systems recognize that no single data source is 100% reliable and therefore draws analogous data from a plurality of data sources. Data is collected and/or received from a plurality of data sources, both structured and unstructured, without fully trusting any individual source such that the dataset built using data from those data sources becomes high trust. The described methods and systems match and compare across various datasets from different data sources on a frequent basis (e.g., continuously, on a rolling basis, and/or in real-time). The described methods and systems are malleable and take into account context and are generally adaptable across the dataset building process. In addition, according to at least some embodiments, the described methods and systems take into account how the data is to be used (purpose) where, for example, real-time access to information is needed in some cases.

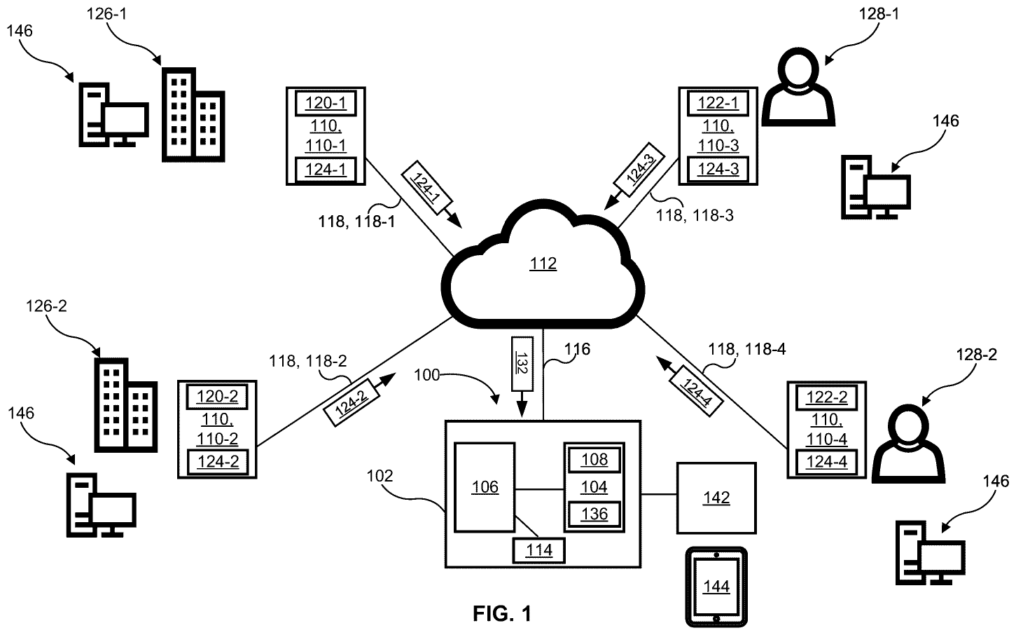

FIG. 1 depicts an exemplary system 100 for building a high trust dataset, according to non-limiting embodiments. System 100 comprises data handling engine 102. Data handling engine 102 comprises at least one memory 104 and at least one processing device 106. Memory 104 can comprise any suitable memory device, including but not limited to any suitable one of, or combination of, a local and/or remote volatile memory, non-volatile memory, random access memory (RAM), read-only memory (ROM), hard drive, optical drive, buffer(s), cache(s), flash memory, magnetic computer storage devices (e.g. hard disks, floppy disks, and magnetic tape), optical memory ((e.g., CD(s) and DVD(s)), and the like. Other suitable memory devices are within the scope of the application. As such, it is understood that the term “memory”, or any variation thereof, as used herein may comprise a tangible and non-transitory computer-readable medium (i.e., a medium which does not comprise only a transitory propagating signal per se) comprising or storing computer-executable instructions, such as computer programs, sets of instructions, code, software, and/or data for execution of any method(s), step(s) or process(es) described herein by any processing device(s) and/or microcontroller(s) described herein. Memory 104 comprises or is enabled to store computer-executable instructions 108 for execution by at least one processing device, including processing device 106. Memory 104 comprises or is further enabled to store high trust dataset 136.

Processing device 106 is coupled to memory 104 and is enabled to control at least some of the operations system 100. As used herein, the terms “processing device”, “processing devices”, “processing device(s)”, “processor”, “processors” or “processor(s)” may refer to any combination of processing devices, and the like, suitable for carrying out the actions or methods described herein. For example, processing device 106 may comprise any suitable processing device, or combination of processing devices, including but not limited to one or multiple microprocessors, central processing units (CPUs), graphics processing units (GPUs), and the like. Other suitable processing devices are within the scope of the application.

Although system 100 is depicted as a single computing system, it is understood that according to some aspects of the application system 100 may comprise multiple computing systems and/or computing devices in which one or more of the computing systems and/or computing devices may be remote from each other (e.g., one or more servers, mobile devices and other suitable computing devices). Although memory 104 and processor 106 are shown as being co-located on the same computing device, it is understood that according to some embodiments, memory 104 and processor 106 may be remote from each other.

System 100 is enabled to communicate with a plurality of data sources, such as data sources 110 (individually data source 110-1, data source 110-2, data source 110-3, and data source 110-4) via, for example, network 112 (which, according to some embodiments, is a secure network). For example, according to some embodiments, system 100 comprises communication module 114 coupled to processor 106. Communication module 114 is enabled to access data sources 110 over network 112 and via, for example, communication links 116 and 118 (individually communication link 118-1, communication link 118-2, communication link 118-3, and communication link 118-4). Communication module 114 comprises any communication device(s) and/or application(s), or combination thereof, suitable for performing the communications with data sources 110 described herein. Communication links 116 and 118 comprise any suitable wired and/or wireless communication link(s), or suitable combination thereof. Communication module 114 is also enabled to communicate according to any suitable protocol which is compatible with network 112. Non-limiting examples of suitable protocols which may be compatible with network 112 are wireless protocols, cell-phone protocols, wireless data protocols, WiFi protocols, WiMax protocols, and/or a combination, or the like, such as Wired Equivalent Privacy (WEP), Wi-Fi Protected Access (WPA), Secure Sockets Layer (SSL) and Transport Layer Security (TLS). Communication module 114 is enabled to process data for transmission between system 100 and data sources 110 in accordance with security protocols associated with network 112. For example, according to some embodiments, communication module 114 is enabled to decrypt data retrieved from any one of data sources 110 via network 112. According to some embodiments, processing device 106 is enabled similarly to communication module 114 such that processing device 106 performs at least some of the communications with data sources 110 described herein rather than communication module 114.

One or more of data sources 110 comprises structured and/or unstructured data, such as unstructured data 120-1 and 120-2 (collectively, unstructured data 120), and structured data 122-1, 122-2 (collectively, structured data 122). For example, structured data for healthcare facilities can include Healthcare c Organization Name, telecommunication information, mailing address, physical location, hours of operations, affiliations, service availability, and many other facility, operational and technical attributes. For example, structured data for healthcare professionals can include name, date of birth, academic credentials, affiliations with professional associations, academic and professional experience, and many other personal and professional attributes. For example, unstructured data about healthcare facilities can include descriptive information about the healthcare facility (e.g., general description of the healthcare facility, historical description of the healthcare facility, recent news associated with the healthcare facility, etc.), services offered, and public discourses related to the organization and services it offers, along with many other informational attributes (such as, for example, information about staff, listings of staff working on a particular day, information about clinicians who work at the healthcare facility such as clinician contact info, clinician availability and/or clinician work schedules, estimated wait-times for specific services/programs, estimated length of wait-list, and preferences related to care coordination and/or service delivery). Although unstructured data 120 and structured data 122 are depicted on separate data sources, according to some embodiments, at least one of data sources 110 comprises both structured and unstructured data.

According to some embodiments, one or more of data sources 110 is associated with an entity or individual that maintains the respective one of data sources 110, such as entities 126-1, 126-2 and individuals 128-1, 128-2. For example, according to some embodiments, at least one of data sources 110, such as data source 110-1, is associated with a healthcare entity (e.g., a pharmacy, hospital, medical clinic, government healthcare agency) and/or an individual (e.g., a patient, physician). Data sources 110 may comprise a variety of data, including data that may be incongruous or otherwise conflict with each other. For example, data source 110-1 and data source 110-2 may both comprise information about the same patient, but some of the information stored at data source 110-1 may not match that held at data source 110-2 (e.g., the date of birth of a patient may be listed as Jan. 15, 1985 at data source 110-1, but is listed as Jan. 21, 1989 at data source 110-2). As another example, data source 110-1 and data source 110-2 may both comprise information about a healthcare professional, but some of the information stored at data source 110-1 may not match that held at data source 110-2 (e.g., a primary care physician was confirmed to be accepting new patients at data source 100-1, while data source 110-2 states that the primary care physician is not actively accepting new patients).

Data sources 110 comprise any suitable data storage type or technical type. For example, according to some embodiments, data sources 110 comprise one or more of a database, a data feed, and a data structure.

According to some embodiments, each one of data sources 110 is updated at a different frequency. For example, according to some embodiments, data source 110-1 may be updated on a real-time basis, whereas data sources 110-2, 110-3 and 110-4 may be updated daily, weekly, monthly, or annually.

Each one of data sources 110 has an associated trust score, such as trust scores 124 (individually, trust score 124-1, 124-2, 124-3 and 124-4). Trust scores 124 may be based on a plurality of factors, such as, for example, the associated entity identity, the historic data reliability of the associated entity, the frequency at which the respective data source is updated, the purpose of the data, the data quality, the data completeness, the data currency (e.g., how recent was the data added or updated, and how frequently is the data updated), as well as any associations and dependencies between data sources. According to some embodiments, trust scores 124 comprise at least one high trust score and at least one low trust score.

It is understood that high trust dataset 136 may comprise any suitable data types or formats. For example, according to some embodiments, high trust dataset 136 comprises a data directory. For example, a high trust dataset 136 could include real-time integration with clinical workflows and/or health IT infrastructure (e.g., Health Information System, Electronic Health Record, Electronic Medical Record) and can be used in automated time-sensitive validation of information directly from the individual or organization for which the information is associated. That is, for example, high trust dataset 136 may be directly accessible by hospital Electronic Health Record systems and clinic Electronic Medical Record systems to support, for example, online appointment booking and care coordination in real-time for same-day bookings, appointment rescheduling, and/or appointment cancellation.

Computer-executable instructions 108, when executed by processor 106, are enabled to cause processor 106 to, repeatedly: retrieve data from a plurality of data sources 110; identify at least one subset 130 of the retrieved data 132 which conflicts with another subset 134 of the retrieved data 130 and/or the high trust dataset 136; for each identified subset of the retrieved data, select one of the plurality of data sources from which the subset will be included in the high trust dataset 136 based on the trust score; based on the trust score, update the high trust dataset 136 to comprise the subset from the selected one of the plurality of data sources; and, update the trust score of at least one of the plurality of data sources.

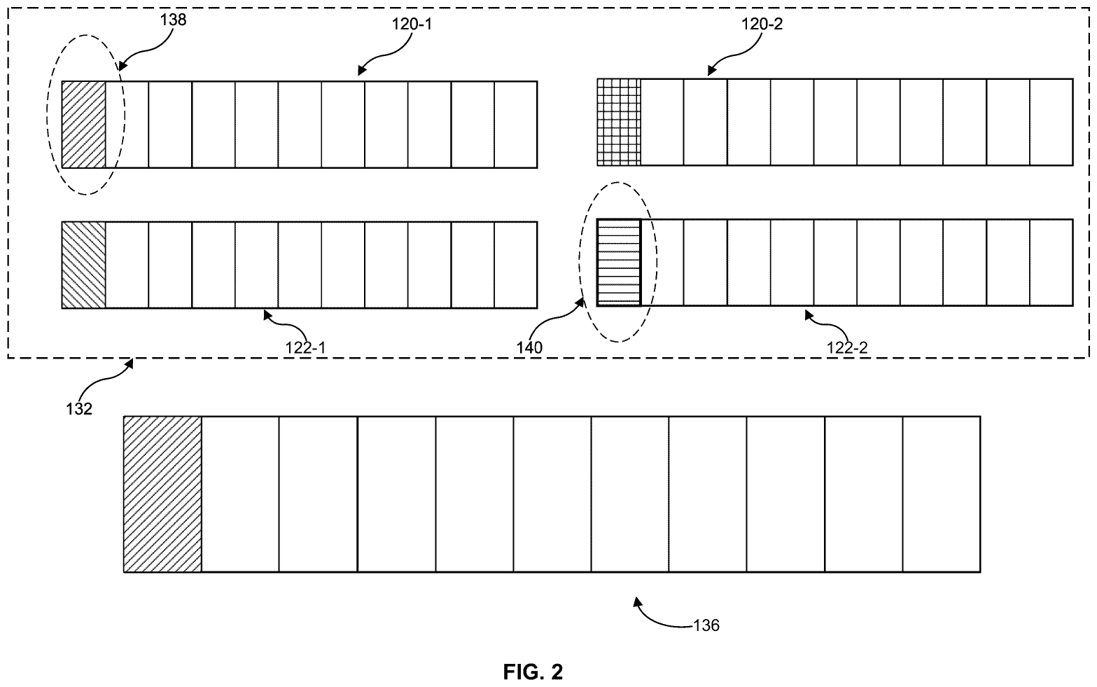

For an illustrative example, attention is directed to FIG. 2, which depicts retrieved data 132 based on unstructured data 120-1, 120-2 and structured data 122-1, 122-2. Each of data sources 110 has a trust score, such as high trust score for data source 110-1, medium trust score for data source 110-2, high trust score for data source 110-3 and medium trust score 110-4. High trust dataset 136, as an initial starting point, may be blank; however, according to some embodiments, high trust dataset 136, as a starting point, comprises at least some data. As noted above, after retrieving the retrieved data 132, at least one subset of the retrieved data, such as subset 138 of unstructured data 120-1, is identified as conflicting with another subset of the retrieved data 132, such as subset 140 of structured data 122-2. According to some embodiments, the identifying comprises identifying the subset and the another subset as analogous, comparing the subset with the another subset of the retrieved data and determining at least one conflict between the subset and the another subset. For example, subset 138 and subset 140 may be identified as analogous if they both comprise physician availability data for the same physician at a certain clinic. Subsets 138 and 140 may conflict, for example, in that for the same date, the physician availability data does not match.

For each identified subset of the retrieved data, one of data sources 110 is selected from which the identified subset will be included in high trust dataset 136. The selection is based on the trust scores of the data sources for each identified subset of the retrieved data. In this illustrative example, since data source 110-1 has a higher trust score than data source 110-4, subset 138 is selected for inclusion in high trust dataset 136. High trust dataset 136 is then updated to include subset 138.

According to some embodiments, at least some of retrieved data is encrypted in transit and encrypted at rest to ensure secure handling of sensitive information, and to reduce data leakage.

In addition to updating high trust dataset 136, the trust score of at least one of the data sources 110 may be updated while the trust score of at least one of the other data sources 110 may be retained. For example, since subset 140 of structured data 122-2 is not selected to be included in high trust dataset 136, trust score 124-2 is updated to reflect a lower trust score.

The frequency at which high trust dataset 136 and/or trust scores 124 are updated may vary. As outlined above, in some examples, trust scores 124 may be updated in response to data being selected, or not, for high trust dataset 136. In other examples, trust scores 124 may be updated on a periodic basis, in view of factors other than data selection for high trust dataset 136. For example, factors which may be based on historic data (e.g., the frequency a source has been updated, the date the source was last updated, assessments that indicate that data for a particular period has better quality, relevant or complete information) or forecasted changes may be used to update the trust score 136 of an entity. Likewise, updating high trust dataset 136 may occur on a periodic basis and/or when data sources 110 indicate updated data is available. According to some embodiments, one or more of updating high trust dataset 136 and trust scores 124 is performed in real-time. According to some embodiments, the updating comprises use of artificial intelligence (AI) and/or data analytics based on, at least in part, one or more of historical data, data context, and data type.

The described methods and systems may also utilize predictive modelling. According to some embodiments, computer-executable instructions 108 is further enabled to cause the processor 106 to predict the updated trust score(s) using AI. That is, for example, historic data and/or information from the data sources may used to generate forecasts which may be used to assign a value and/or predict the updated trust scores. In some examples, the updated trust scores assigned by AI may be validated when comparing the actual trust score and quality of the information to the forecasted information. According to some embodiments, the frequency and timing of updates to one or more of data sources 110 as an indication of data quality is performed using AI.

According to some embodiments, the use of AI in the described methods and systems comprises one or more of machine learning and artificial generative intelligence (AGI). According to some embodiments, the machine learning comprises use of one or more neural networks.

As indicated above, the described systems are configured to repeat the described process. For example, according to some embodiments, the repetition is continuous such that high trust dataset 136 and trust scores 124 are being updated on a continuous basis. According to some embodiments, the frequency of the repetition is in accordance with the results of applied AI.

According to some embodiments, system 100 further comprises application programming interface (API) 142 through which the functionalities and/or outputs of data handling engine 102 can be accessed. For example, according to some embodiments, API 142 is configured to provide a navigation service which may communicate with internal and external applications such as, without limitation, patient portals, digital front door, wayfinding websites, wayfinding applications, eReferral programs, eConsult programs, ride-sharing platforms, public transit services, clinical services providers, service providers at various governmental levels (such as at the municipal, regional and national-level) and service providers at the institutional level (e.g., retail chains, banners, professional groups). According to some embodiments, API 142 provides backend access for authorized users to data handling engine 102. For example, according to some embodiments, API 142 provides access to AI prompts and/or models to enable modification of same.

API 142 may be accessed by one or more computing devices, such as computing device 144. Computing device 144 comprises any suitable computing device, including but not limited to one or more portable electronic devices, mobile computing devices, portable computing devices, tablet computing devices, laptop computing devices, PDAs (personal digital assistants), cellphones, smartphones, computer terminals and the like. Other suitable computing devices are within the scope of the application. For the sake of simplicity, a single computing device 144 is shown in FIG. 1. However, according to some aspects, more than one computing device 144 is enabled to access API 142.

According to some embodiments, other functionalities of data handling engine 102, such as the outputs, may be accessed via computing devices 146 accessible by individuals 128 and/or entities 126. Computing devices 146 comprise any suitable computing devices, including but not limited to one or more portable electronic devices, mobile computing devices, portable computing devices, tablet computing devices, laptop computing devices, PDAs (personal digital assistants), cellphones, smartphones, computer terminals and the like. Other suitable computing devices are within the scope of the application.

Providing access to high trust dataset 136, may provide efficiency and improvement to downstream systems (e.g., computing device 144). That is, without high trust dataset 136, downstream systems and/or persons may individually be required to evaluate the accuracy of certain data, which may require excess human and/or computer resources. This resource savings may be amplified when there are multiple downstream systems.

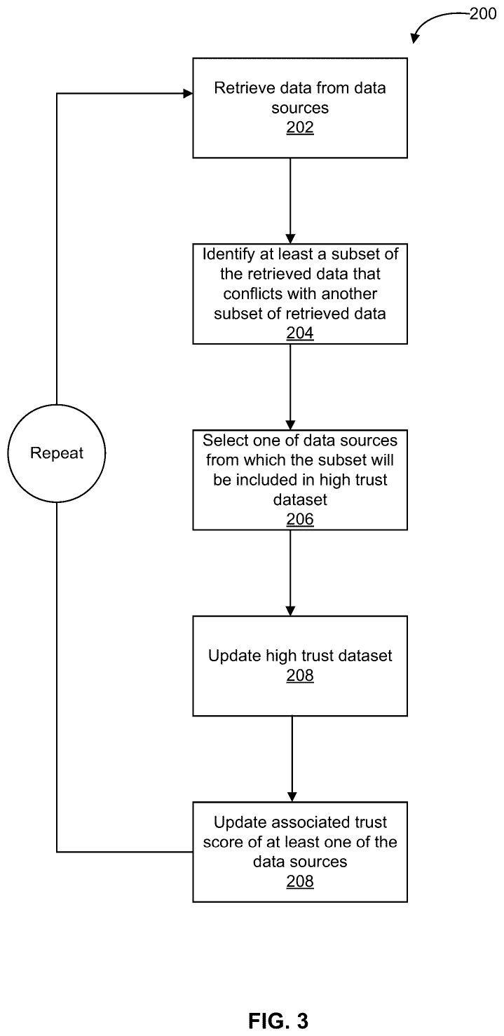

Attention is now directed to FIG. 3 which depicts a flowchart of a method 200 of building a high trust dataset, according to non-limiting aspects of the application. In order to assist in the explanation of method 200, it will be assumed that method 200 is performed using system 100. Furthermore, the following discussion of method 200 will lead to a further understanding of system 100, and the various components of that system. However, it is to be understood that system 100 can be varied, and need not work exactly as discussed herein, and that such variations are within the scope of present implementations.

It is appreciated that, in some aspects, method 200 is implemented by system 100 by processing device 106. Indeed, method 200 is one way in which system 100 may be configured. It is to be emphasized, however, that method 200 need not be performed in the exact sequence as shown, unless otherwise indicated; and likewise various blocks may be performed in parallel rather than in sequence; hence the elements of method 200 are referred to herein as “blocks” rather than “steps”. It is also to be understood, however, that method 200 can be implemented on variations of system 100 as well.

At block 202, data 132 is retrieved from data sources 110, wherein one or more of data sources 110 comprises structured and/or unstructured data and each one of data sources 110 has an associated trust score (which may be a default low score, for example).

At block 204, at least one subset of the retrieved data, such as subset 138, is identified as conflicting with another subset of the retrieved data (such as subset 140) or the high trust dataset 136.

At block 206, for each identified subset of the retrieved data, one of data sources 110 is selected from which the subset will be included in the high trust dataset based on the trust associated trust score.

At block 208, based on the associated trust score, high trust dataset 136 is updated to include the subset from the selected one of data sources 110.

At block 210, the associated trust score of at least one of data sources 110 is updated.

As noted above, method 200 is repeated, which may be continuously and/or as otherwise described above.

Those skilled in the art will appreciate that in some implementations, the functionality of system 100 and method 200 can be implemented using pre-programmed hardware or firmware elements (e.g., application specific integrated circuits (ASICs), electrically erasable programmable read-only memories (EEPROMs), etc.), or other related components. In other implementations, the functionality of system 100 and method 200 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative aspects and modifications possible, and that the above examples are only illustrations of one or more aspects of the application. The scope, therefore, is only to be limited by the claims appended hereto.

### INTERPRETATION

It will also be understood that for the purposes of this application, “at least one of X, Y, and Z” or “one or more of X, Y, and Z” language can be construed as X only, Y only, Z only, or any combination of two or more items X, Y, and Z (e.g., XYZ, XYY, YZ, ZZ).

In the present application, components may be described as “configured to” or “enabled to” perform one or more functions. Generally, it is understood that a component that is configured to or enabled to perform a function is configured to or enabled to perform the function, or is suitable for performing the function, or is adapted to perform the function, or is operable to perform the function, or is otherwise capable of performing the function.

Additionally, components in the present application may be described as “operatively connected to”, “operatively coupled to”, and the like, to other components. It is understood that such components are connected or coupled to each other in a manner to perform a certain function. It is also understood that “connections”, “coupling” and the like, as recited in the present application include direct and indirect connections between components.

References in the application to “one embodiment”, “an embodiment”, “an implementation”, “a variant”, etc., indicate that the embodiment, implementation or variant described may include a particular aspect, feature, structure, or characteristic, but not every embodiment, implementation or variant necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely”, “only”, and the like, in connection with the recitation of claim elements or use of a “negative” limitation. The terms “preferably”, “preferred”, “prefer”, “optionally”, “may”, and similar terms are used to indicate that an item, condition or step being referred to is an optional (not required) feature of the invention.

The singular forms “a”, “an”, and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

What is claimed is:

1. A method for building a high trust dataset, comprising:
repeatedly,
retrieving data from a plurality of data sources, wherein one or more of the plurality of data sources comprises structured and/or unstructured data and each one of the plurality of data sources has an associated trust score,
identifying at least one subset of the retrieved data which conflicts with at least one of another subset of the retrieved data and the high trust dataset,
for each identified subset of the retrieved data, selecting one of the plurality of data sources from which the subset will be included in the high trust dataset based on the associated trust score,
based on the trust score, updating the high trust dataset to comprise the subset from the selected one of the plurality of data sources, and
updating the associated trust score of at least one of the plurality of data sources.

2. The method of claim 1, wherein the identifying comprises:
identifying the subset and the another subset as analogous;
comparing the subset with the another subset of retrieved data; and
determining at least one conflict between the subset and the another subset.

3. The method of claim 1, wherein the identifying comprises identifying each of the subset, the another subset, and a subset of the high trust dataset as conflicting.

4. The method of claim 1, wherein the trust scores of the plurality of data sources comprises at least one high trust score and at least one low trust score.

5. The method of claim 1, wherein the plurality of data sources comprises one or more of a database, a data feed and a data structure.

6. The method of claim 1, wherein each one of the plurality of data sources is updated at different frequencies.

7. The method of claim 1, wherein at least one of the plurality of data sources is associated with a healthcare entity.

8. The method of claim 1, wherein the updating comprises updating in in real-time.

9. The method of claim 1, wherein the updating comprises use of at least one of artificial intelligence and data analytics.

10. The method of claim 9, wherein at least one of the artificial intelligence and the data analytic is based on one or more of historical data, contextual data and data type.

11. The method of claim 1, further comprising predicting a trust score of a data source using artificial intelligence.

12. The method of claim 9, wherein the artificial intelligence comprises one or more of machine learning and artificial generative intelligence.

13. The method of claim 12, wherein the machine learning comprises one or more artificial neural networks.

14. The method of claim 1, wherein a frequency of the repeating is in accordance with the results of applied artificial intelligence.

15. The method of claim 1, further comprising providing the high trust dataset to at least one downstream system.

16. A system for building a high trust dataset, comprising:
a data handling engine in communication with a plurality of data sources,
at least one memory device configured to store computer-executable instructions and the high trust dataset, and
a processing device coupled to the memory device;
wherein the computer executable instructions when executed by the processing device causes the processing device to:
repeatedly,
retrieve data from the plurality of data sources, wherein one or more of the plurality of data sources comprises structured and/or unstructured data and each one of the plurality of data sources has an associated trust score,
identify at least one subset of the retrieved data which conflicts with at least one of another subset of the retrieved data and the high trust dataset,
for each identified subset of the retrieved data, select one of the plurality of data sources from which the subset will be included in the high trust dataset based on the trust score,
based on the trust score, update the high trust dataset stored at the at least one memory device to comprise the subset from the selected one of the plurality of data sources, and
update the trust score of at least one of the plurality of data sources.

17. The system of claim 16, wherein the retrieved data is encrypted and the computer-executable instructions when executed by the processing device further causes the processing device to decrypt the retrieved data.

18. The system of claim 16, further comprising an application interface for the data handling engine.

19. The system of claim 16, further comprising a plurality of downstream systems having access to the high trust dataset.

20. A non-transitory computer readable medium for building a high trust dataset, comprising computer-executable instructions for:
repeatedly,
retrieving data from a plurality of data sources, wherein one or more of the plurality of data sources comprises structured and/or unstructured data and each one of the plurality of data sources has an associated trust score,
identifying at least one subset of the retrieved data which conflicts with another subset of the retrieved data and/or the high trust dataset,
for each identified subset of the retrieved data, selecting one of the plurality of data sources from which the subset will be included in the high trust dataset based on the trust score,
based on the trust score, updating the high trust dataset to comprise the subset from the selected one of the plurality of data sources, and
updating the trust score of at least one of the plurality of data sources.
